(19) United States
(12) Patent Application Publication
(10) Pub. No.: US 2025/0270738 A1
(43) Pub. Date: Aug. 28, 2025

(54) PROCESS FOR MAKING PURE, BLENDED, AND COAXIAL FIRE-RESISTANT NANOFIBERS

(71) Applicants: TEXAS STATE UNIVERSITY, San Marcos, TX (US); D.J. IRVIN COMPANY, LLC, San Marcos, TX (US)

(72) Inventors: Jennifer A. Irvin, San Marcos, TX (US); David J. Irvin, San Marcos, TX (US); Melany Bouyer, Austin, TX (US); Nicholas R. Lontkowski, Martindale, TX (US)

(73) Assignees: TEXAS STATE UNIVERSITY, San Marcos, TX (US); D.J. IRVIN COMPANY, LLC, San Marcos, TX (US)

(21) Appl. No.: 19/063,204

(22) Filed: Feb. 25, 2025

Related U.S. Application Data
(60) Provisional application No. 63/557,979, filed on Feb. 26, 2024.

(51) Int. Cl. D01F 1/07; D01D 1/02; D01D 5/00; D01F 6/18; D01F 6/94; D01F 8/08; D01F 8/16; H01M 10/42; H01M 50/42; H01M 50/44; H01M 50/489

(52) U.S. Cl. CPC D01F 1/07; D01D 1/02; D01D 5/0038; D01D 5/0076; D01F 6/18; D01F 6/94; D01F 8/08; D01F 8/16; H01M 10/4235; H01M 50/42; H01M 50/44; H01M 50/489; D10B 2321/10; D10B 2331/10; D10B 2401/04; D10B 2505/00

(57) ABSTRACT

Embodiments of the present disclosure pertain to methods of making a flame-retardant fiber on a surface through (a) electrospinning a polymer onto the surface; and (b) electrospinning a flame-retardant polymeric additive onto the surface. Additional embodiments of the present disclosure pertain to flame-retardant fiber that include: (a) a polymer; and (b) a flame-retardant polymeric additive associated with the polymer.

### CROSS-REFERENCE TO RELATED APPLICATIONS

This application claims priority to U.S. Provisional Patent Application No. 63/557,979, filed on Feb. 26, 2024. The entirety of the aforementioned application is incorporated herein by reference.

### BACKGROUND

A need exists for improved methods of efficiently fabricating tailored fibers for specific needs and with optimal properties. Numerous embodiments of the present disclosure aim to address the aforementioned needs.

### SUMMARY

Embodiments of the present disclosure pertain to methods of making a flame-retardant fiber on a surface through (a) electrospinning a polymer onto the surface; and (b) electrospinning a flame-retardant polymeric additive onto the surface. Additional embodiments of the present disclosure pertain to flame-retardant fibers that include: (a) a polymer; and (b) a flame-retardant polymeric additive associated with the polymer.

In some embodiments, a single electrospinning apparatus may be used to electrospin a polymer and a flame-retardant polymeric additive onto a surface by: (a) mixing the polymer with the flame-retardant polymeric additive to form a mixture; (b) loading the mixture into an electrospinning apparatus; and (c) electrospinning the mixture onto the surface to form the fiber on the surface.

In some embodiments, a first electrospinning apparatus is used to electrospin a polymer onto a surface, and a second electrospinning apparatus is used to electrospin a flame-retardant polymeric additive onto the surface. In some embodiments, such methods include: (a) loading a polymer into a first electrospinning apparatus and electrospinning the polymer onto a surface; and (b) loading a flame-retardant polymeric additive onto a second electrospinning apparatus and electrospinning the flame-retardant polymeric additive onto the surface.

### FIGURES

FIG. 1 provides an illustration of an electrospinning process.

FIG. 2 provides a cross-section of blended fiber 10, which contains a homogeneous mixture of a polymer 12 and a flame-retardant polymeric additive 14.

FIG. 3 provides a cross-section of coaxial fiber 20, which includes a polymer 22 on the outside and a flame-retardant polymeric additive 24 on the inside.

FIG. 4 provides a cross-section of coaxial fiber 30, which includes a polymer 32 on the inside and a flame-retardant polymeric additive 34 on the outside.

FIG. 5 provides a scanning electron micrograph (SEM) of polyacrylonitrile (PAN) and flame-retardant polymeric additive blended fibers spun under the following conditions: flow rate of 0.02 mL/mm; voltage of 15,000 V; drum speed of 100 RPM; and distance of 6 inches.

FIG. 6 shows an SEM of PAN and flame-retardant polymeric additive blended fibers spun under the following conditions: flow rate of 0.035 mL/mm; voltage of 20,800 V; drum speed of 100 RPM; and distance of 2 inches.

FIG. 7 shows an SEM of PAN and flame-retardant polymeric additive blended fibers spun under the following conditions: flow rate of 0.035 mL/mm; voltage of 20,800 V; drum speed of 100 RPM; and distance of 2 inches.

FIGS. 8A-8E show experimental results and SEMs of fibers of PAN with PolyCat. SEMs of the resultant fibers are shown in FIGS. 8A-8D at magnifications of 1000× (FIG. 8A), 1500× (FIG. 8B), 2000× (FIG. 8C), and 3500× (FIG. 8D). Energy dispersive X-ray spectroscopy (EDS) analyses of the fibers are shown in FIG. 8E.

FIGS. 9A-9E show experimental results and SEMs of fibers of PAN with PC1. SEMs of the resultant fibers are shown in FIGS. 9A-9D at magnifications of 1000× (FIG. 9A), 1500× (FIG. 9B), 2000× (FIG. 9C), and 3500× (FIG. 9D). EDS analyses of the fibers are shown in FIG. 9E.

FIGS. 10A-10E show experimental results and SEMs of fibers of PAN with PC1. SEMs of the resultant fibers are shown in FIGS. 10A-10D at magnifications of 1000× (FIG. 10A), 1500× (FIG. 10B), 2000× (FIG. 10C), and 3500× (FIG. 10D). EDS analyses of the fibers are shown in FIG. 10E.

FIGS. 11A-11E show experimental results and SEMs of fibers of PAN with PCI. SEMs of the resultant fibers are shown in FIGS. 11A-11D at magnifications of 1000× (FIG. 11A), 1500× (FIG. 11B), 2000× (FIG. 11C), and 3500× (FIG. 11D). Energy dispersive X-ray spectroscopy (EDS) analyses of the fibers are shown in FIG. 11E.

FIGS. 12A-12D show test results of the flame retarding properties of various fibers.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Current fiber fabrication methods suffer from numerous limitations, such as the inability to control a formed fiber's properties for specific applications. As such, current fiber fabrication methods form fibers with sub-optimal properties, such as sub-optimal textures, sub-optimal surface areas, and sub-optimal flame retardant properties.

As such, a need exists for improved methods of efficiently fabricating tailored fibers for specific needs. A need also exists for fabricating fibers with optimal properties, such as optimal textures, optimal surface areas, and optimal flame retardant properties. Numerous embodiments of the present disclosure aim to address the aforementioned needs.

### Flame-Retardant Fibers and Methods of Making Them

In some embodiments, the present disclosure pertains to a method of making a flame-retardant fiber on a surface. In some embodiments, the methods of the present disclosure include steps of: (a) electrospinning a polymer onto the surface; and (b) electrospinning a flame-retardant polymeric additive onto the surface.

Additional embodiments of the present disclosure pertain to flame-retardant fibers. In some embodiments, the fibers of the present disclosure are made by the methods of the present disclosure. In some embodiments, the fibers of the present disclosure include: (a) a polymer; and (b) a flame-retardant polymeric additive associated with the polymer.

As set forth in more detail herein, the methods of the present disclosure have numerous embodiments. Moreover, the fibers of the present disclosure can include various components and forms.

### Surfaces

The methods of the present disclosure may electrospin polymers and flame-retardant polymeric additives onto various surfaces. For instance, in some embodiments, the surface includes a metal plate. In some embodiments, the surface includes a collector (i.e., a solid or liquid surface that can be electrically grounded or have the opposite voltage of the applied voltage). In some embodiments, the collector includes, without limitation, rotating drums, foil, an empty soda can, a piece of plastic, a liquid, a battery surface (e.g., battery surfaces referenced herein), or combinations thereof.

In some embodiments, the surface includes a battery surface. In such embodiments, the methods of the present disclosure may be used to form a fiber as a component of a battery, such as a separator of the battery.

### Electrospinning Conditions

The methods of the present disclosure may utilize various electrospinning conditions. For instance, electrospinning can occur at various flow rates. In some embodiments, the electrospinning occurs at a flow rate of at least about 0.01 mL/mm. In some embodiments, the electrospinning occurs at a flow rate ranging from about 0.01 mL/mm to about 0.1 mL/mm. In some embodiments, the electrospinning occurs at a flow rate ranging from about 0.01 mL/mm to about 0.05 mL/mm. In some embodiments, the electrospinning occurs at a flow rate ranging from about 0.02 mL/mm to about 0.04 mL/mm.

Electrospinning can occur at various voltages. For instance, in some embodiments, the electrospinning occurs at a voltage of at least about 10,000 V. In some embodiments, the electrospinning occurs at a voltage ranging from about 10,000 V to about 30,000 V. In some embodiments, the electrospinning occurs at a voltage ranging from about 10,000 V to about 25,000 V. In some embodiments, the electrospinning occurs at a voltage ranging from about 10,000 V to about 21,000 V. In some embodiments, the electrospinning occurs at a voltage ranging from about 15,000 V to about 18,000 V. In some embodiments, the electrospinning occurs at a voltage of at least about 600 V.

Electrospinning can occur at various drum speeds. For instance, in some embodiments, the electrospinning occurs at a drum speed of at least about 10 RPM. In some embodiments, the electrospinning occurs at a drum speed ranging from about 10 RPM to about 1,000 RPM. In some embodiments, the electrospinning occurs at a drum speed ranging from about 100 RPM to about 500 RPM. In some embodiments, the electrospinning occurs at a drum speed ranging from about 100 RPM to about 250 RPM. In some embodiments, the electrospinning occurs at a drum speed of at least about 1,000 RPM.

Electrospinning can occur at various surface distances. For instance, in some embodiments, the electrospinning occurs at a surface distance of at least about 1 inch. In some embodiments, the electrospinning occurs at a surface distance ranging from about 1 inch to about 24 inches. In some embodiments, the electrospinning occurs at a surface distance ranging from about 2 inches to about 20 inches. In some embodiments, the electrospinning occurs at a surface distance ranging from about 2 inches to about 6 inches.

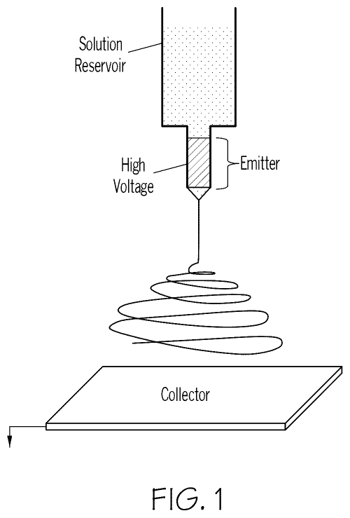

The methods of the present disclosure may utilize various electrospinning apparatus. An example of an electrospinning apparatus that could be utilized in accordance with the methods of the present disclosure is illustrated in FIG. 1.

In some embodiments, a single electrospinning apparatus may be used to electrospin a polymer and a flame-retardant polymeric additive onto a surface (i.e., the “single composition” method). In some embodiments, the electrospinning of the polymer and the flame-retardant polymeric additive includes: (a) mixing the polymer with the flame-retardant polymeric additive to form a mixture; (b) loading the mixture into an electrospinning apparatus; and (c) electrospinning the mixture onto the surface to form the fiber on the surface. In some embodiments, the mixing occurs for at least 1 hour. In some embodiments, the mixing occurs for at least 12 hours. In some embodiments, the mixing occurs for at least 24 hours.

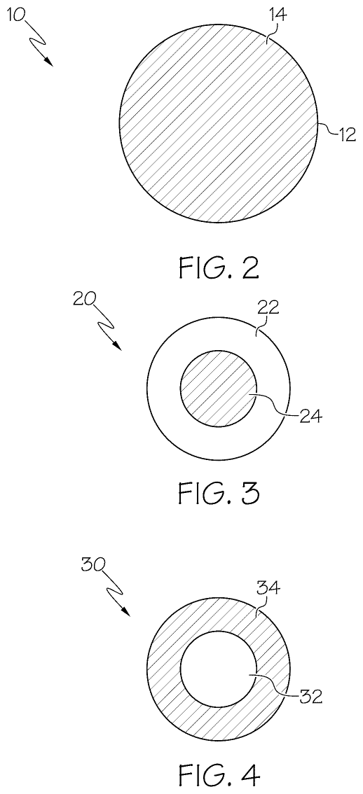

In some embodiments, the “single composition method” forms fibers that include an intertwined blend of a polymer and a flame-retardant polymeric additive. In some embodiments, the fibers of the present disclosure include an intertwined blend of a polymer and a flame-retardant polymeric additive. In some embodiments illustrated in FIG. 2, the fiber may be in the form of fiber 10 with an intertwined blend of polymer 12 and flame-retardant polymeric additive 14.

In some embodiments, the “single composition method” forms fibers that include an intertwined blend of a polymer and a flame-retardant polymeric additive. In some embodiments, the ratio of the polymer to the flame-retardant polymeric additive can range from 95 weight % polymer to 5 weight % of the flame-retardant polymeric additive to 5 weight % polymer to 95 weight % flame-retardant polymeric additive. In some embodiments, the ratio of the polymer to flame-retardant polymeric additive can be 80 weight % polymer to 20 weight % of the flame-retardant polymeric additive. In some embodiments, the ratio of the polymer to flame-retardant polymeric additive can be 20 weight % polymer to 80 weight % flame-retardant polymeric additive. In some embodiments, the ratio of the polymer to flame-retardant polymeric additive can be 60 weight % polymer to 40 weight % of the flame-retardant polymeric additive. In some embodiments, the ratio of the polymer to flame-retardant polymeric additive can be 40 weight % polymer to 60 weight % flame-retardant polymeric additive. In some embodiments, the ratio of the polymer to the flame-retardant polymeric additive can be with 50 weight % polymer to 50 weight % of the flame-retardant polymeric additive.

In some embodiments, a first electrospinning apparatus is used to electrospin a polymer onto a surface, and a second electrospinning apparatus is used to electrospin a flame-retardant polymeric additive onto the surface (i.e., the “coaxial composition” method). In some embodiments, the method includes: (a) loading a polymer into a first electrospinning apparatus and electrospinning the polymer onto a surface; and (b) loading a flame-retardant polymeric additive onto a second electrospinning apparatus and electrospinning the flame-retardant polymeric additive onto the surface.

In some embodiments, the “coaxial composition” method forms a coaxial fiber of a polymer and a flame-retardant polymeric additive. In some embodiments, the formed fiber is in the form of a two-part fiber. In some embodiments, the fibers of the present disclosure include such a two-part fiber. In some embodiments, the two-part fiber includes the polymer completely or partially containing the flame-retardant polymeric additive. In some embodiments, the fiber includes the polymer on the outside of the fiber and the flame-retardant polymeric additive on the inside of the fiber. An example of a two-part fiber is illustrated in FIG. 3 as fiber 20, which includes polymer 22 completely containing flame-retardant polymeric additive 24, where polymer 22 is on the outside of fiber 20, and where flame-retardant polymeric additive 24 is on the inside of fiber 20.

In some embodiments, the two-part fiber includes a flame-retardant polymeric additive completely or partially containing a polymer. In some embodiments, the fiber includes the polymer on the inside of the fiber and the flame-retardant polymeric additive on the outside of the fiber. An example of such a two-part fiber is illustrated in FIG. 4 as fiber 30, which includes flame-retardant polymeric additive 34 containing polymer 32, where polymer 32 is on the inside of fiber and flame-retardant polymeric additive 34 is on the outside of the fiber.

### Polymers

The methods of the present disclosure may utilize various polymers to form fibers. Additionally, the fibers of the present disclosure may include various polymers. For instance, in some embodiments, the polymer includes, without limitation, polyacrylonitriles, nylons, polyesters, polyolefins, thermoplastic polymers, or combinations thereof. In some embodiments, the polymer includes polyacrylonitrile.

The polymers of the present disclosure can have various molecular weights. For instance, in some embodiments, the polymers of the present disclosure have a molecular weight of more than 10 kilodaltons. In some embodiments, the polymers of the present disclosure have a molecular weight of more than 30 kilodaltons. In some embodiments, the polymers of the present disclosure have a molecular weight ranging from about 10 kilodaltons to about 3,000 kilodaltons.

### Flame-Retardant Polymeric Additives

The methods of the present disclosure may utilize various flame-retardant polymeric additives to form fibers. Additionally, the fibers of the present disclosure may include various flame-retardant polymeric additives. For instance, in some embodiments, flame-retardant polymeric additives include, without limitation, phosphine-containing polymers, phosphine oxide-containing polymers, phosphine oxide poly(pyridinium), poly(pyridinium), poly(pyridinium) without phosphine oxide, poly(4,4′-(p-phenylene)-bis(2,6-diphenyl pyridinium)) di(4-methylbenzene sulfonate, or combinations thereof. In some embodiments, the flame-retardant polymeric additive includes phosphine oxide poly(pyridinium). In some embodiments, the flame-retardant polymeric additive includes poly(pyridinium) without phosphine oxide. In some embodiments, the flame-retardant polymeric additive includes poly(4,4′-(p-phenylene)-bis(2,6-diphenyl pyridinium)) di(4-methylbenzene sulfonate.

In some embodiments, the flame retardant polymeric additives include an organic polymer with a charge and an organic anion to balance the charge. In some embodiments, the organic anion includes, without limitation, halide ions, sulfates, phosphates, nitrates, carbonates, borates, or combinations thereof. In some embodiments, flame-retardant polymeric additives include poly(pyridinium). In some embodiments, the poly(pyridinium) contains a cationic charge in the backbone of the polymer. In some embodiments, the cationic charge is counterbalanced by an anion. In some embodiments, the counter ion is para-toluene sulfonate.

### Charges

The polymers and polymeric additives of the present disclosure can include various charges. For instance, in some embodiments, the polymer has a net charge that is opposite the net charge of the flame-retardant polymeric additive. In some embodiments, the polymer has a net negative charge while the flame-retardant polymeric additive has a net positive charge. In some embodiments, the polymer has a net positive charge while the flame-retardant polymeric additive has a net negative charge.

In some embodiments, opposite charges on polymers and polymeric additives render the fibers insoluble. In some embodiments, such insolubility can be advantageous for various applications, such as the use of the fibers as battery components (e.g., separators).

### Fiber Forms

The methods of the present disclosure may be utilized to form various types of fibers. Additionally, the fibers of the present disclosure can be in various forms. For instance, in some embodiments, the fiber is a non-flammable fiber. In some embodiments, the fiber has a linear orientation. In some embodiments, the fiber is in the form of a microfiber. In some embodiments, the fiber is in the form of a nanofiber.

In some embodiments, the fiber has a diameter ranging from about 10 nm to about 1000 nm. In some embodiments, the fiber has a diameter ranging from about 10 nm to about 100 nm. In some embodiments, the fiber has a diameter of less than about 100 nm.

In some embodiments, the fiber has a surface area ranging from about 5 m²/g to about 500 m²/g. In some embodiments, the fiber has a surface area ranging from about 20 m²/g to about 100 m²/g. In some embodiments, the fiber has a surface area ranging from about 25 m²/g to about 75 m²/g.

In some embodiments, the fiber is in the form of an insoluble fiber. In some embodiments, the fiber is in the form of a fiber mat.

### Advantages and Applications

The methods and fibers of the present disclosure provide numerous advantages over existing methods and fibers. For instance, in some embodiments, the fibers formed by the methods of the present disclosure have smaller diameters than traditionally spun fibers (e.g., diameters of less than 100 nm). In some embodiments, such smaller diameters enhance a fiber's texture and increase a fiber's surface area.

In some embodiments, the electrospinning process provides the ability to modify a formed fiber's composition and thereby tailor a fiber's properties for specific applications. Such tailored methods allow for the efficient fabrication of flame retardant fibers at reduced cost and enhanced performance.

As such, the methods and fibers of the present disclosure provide numerous advantages. For instance, in some embodiments, the methods of the present disclosure can be utilized to fabricate fibers for various purposes, such as children's clothing, personal protective gear for first responders, lithium ion battery separators, furniture, transportation, and other similar applications.

### Additional Embodiments

Reference will now be made to more specific embodiments of the present disclosure and experimental results that provide support for such embodiments. However, Applicant notes that the disclosure herein is for illustrative purposes only and is not intended to limit the scope of the claimed subject matter in any way.

### Example 1

### Fabrication of Single Composition Fibers

This Example provides a protocol for the synthesis of single composition fibers, as described in the present disclosure. A flame-resistant polymer was dissolved in a solvent (in this Example acetonitrile, dimethylformamide, or dimethyl sulfoxide) at various concentrations (in this Example 20 wt %). A solution of a commodity (common) polymer (in this Example polyacrylonitrile) was dissolved in the same solvent at various concentrations (ranging from 1 wt % to 30 wt %). The two solutions were combined and stirred for 24 hours. The resulting solutions were then transferred to a syringe and the syringe was placed on a syringe pump. The voltage was increased until a Taylor cone formed. The pump speed was controlled to vary the fiber diameter. The fibers were made as a random mat by grounding a flat metal plate as the target to the voltage supply. Linear oriented fiber (x-axis) mats were made by using a rotating drum as the grounded target. The x/y oriented mats were made by using a rotating drum (x-axis) as the grounded target and rastering the spinneret (y-axis).

### Example 2

### Fabrication of Coaxial Composition Fibers

This Example provides a protocol for the synthesis of coaxial composition fibers, as described in the present disclosure. A flame-resistant polymer was dissolved in a solvent (in this Example acetonitrile, dimethyl formamide, or dimethyl sulfoxide) at various concentrations (in this Example 20 wt %). A solution of a commodity (common) polymer (in this Example polyacrylonitrile) was dissolved in the same solvent at various concentrations (ranging from 1 wt % to 30 wt %). Each of the resulting solutions was then transferred to separate syringes and the syringes were placed on their own syringe pumps. The voltage was increased until a Taylor cone formed. The flow of each of the pumps was controlled to have a greater fraction of the inside or outside polymer in the resultant fiber. The fibers were made as a random mat by grounding a flat metal plate or slowly rotating drum as the target to the voltage supply. Linear oriented fiber (x-axis) mats were made by using a rapidly rotating drum as the grounded target. The x/y oriented mats were made by using a rapidly rotating drum (x-axis) as the grounded target and rastering the spinneret (y-axis).

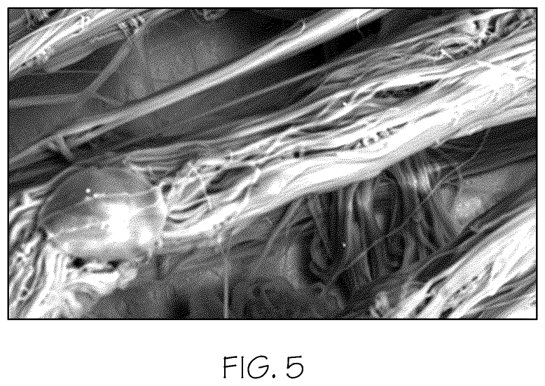

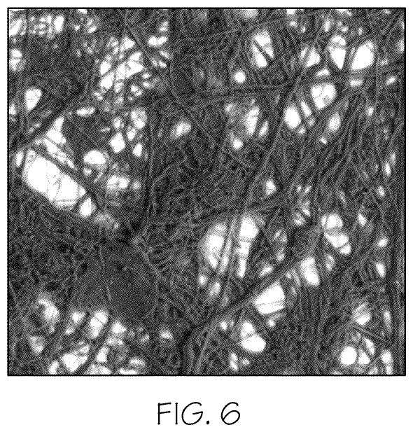

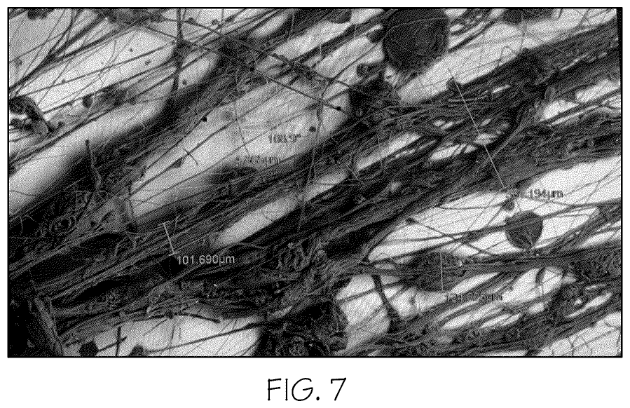

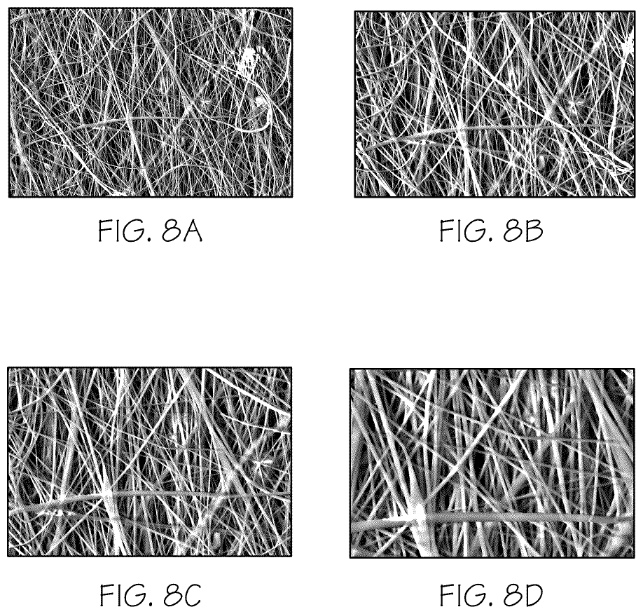

FIGS. 5-7 provide SEM images of fibers formed by methods described in Examples 1-2. In FIG. 5, a solution is 5 weight percent polyacrylonitrile (PAN):to 5 weight percent Polycat 1 (PC1) dissolved in dimethyl sulfoxide (DMSO) with trace NaCl added to enhance the conductivity to improve the electrospinning. The parameters used were flow rate 0.02 mL/mm, voltage 15,000V, drum speed 100 rpm, and at a distance of 6 inches. In FIG. 6, a solution is 5 weight percent polyacrylonitrile (PAN): to 5 weight percent Polycat 1 (PC1) dissolved in DMSO with trace LiCl added to enhance the conductivity to improve the electrospinning (poly(4,4′-(p-phenylene)-bis(2,6-diphenyl pyridinium)) di (4-methylbenzene sulfonate represents PolyCat 1; PC1). The parameters used were flow rate 0.035 mL/mm, voltage 20,800V, drum speed 100 rpm, and at a distance of 2 inches. In FIG. 7, a solution is 5 weight percent polyacrylonitrile (PAN): to 5 weight percent Polycat 1 (PC1) dissolved in DMSO with trace LiCl added to enhance the conductivity to improve the electrospinning. The parameters used were flow rate 0.035 mL/mm, Voltage 20,800V, Drum Speed 100 rpm, and at a distance of 2 inches.

### Example 3

### Electrospinning of Polyacrylonitrile (PAN) with PolyCat

In this Example, polyacrylonitrile (PAN) was used as the carrier polymer for a flame retardant polymer class of PolyCat (produce of Quantum Copper). The electrospinning parameters were as follows: 10 wt % of PAN in dimethylformamide (DMF); Voltage: 17.5 kV; Working Distance: 110 mm; Flow Rate: 0.05 mL/min; Drum Speed: 800 rpm.

The resultant experiment produced a mat of fibers between 100 and 1000 nm. Scanning electron micrographs of the resultant fibers are shown in FIGS. 8A-8D at magnifications of 1000× (FIG. 8A), 1500× (FIG. 8B), 2000× (FIG. 8C), and 3500× (FIG. 8D). Energy dispersive X-ray spectroscopy (EDS) analysis was used to determine the elements found in each sample. The EDS results are shown in FIG. 8E. Only carbon (C) and nitrogen (N) were detected, which are the only PAN components.

### Example 4

### Electrospinning of a PAN-PC1 (1:1) Solution

In this Example, polyacrylonitrile (PAN) was used as the carrier polymer for a flame retardant polymer class of PolyCat 1 (produce of Quantum Copper, PC1) in a 1 to 1 ratio to produce a homogeneous blend of two polymers. This blend will have equal amounts of combustible polymer (PAN) and non-combustible polymer (PolyCat 1) on the surface of the fibers. 1 solution of 5 wt % PAN in DMF was combined with 1 solution of 5 wt % PCI in dimethylformamide (DMF). Electrospinning occurred under the following parameters: voltage: 17.0 kV; Working Distance: 90 mm; Flow Rate: 0.04 mL/min; and Drum Speed: 800 rpm.

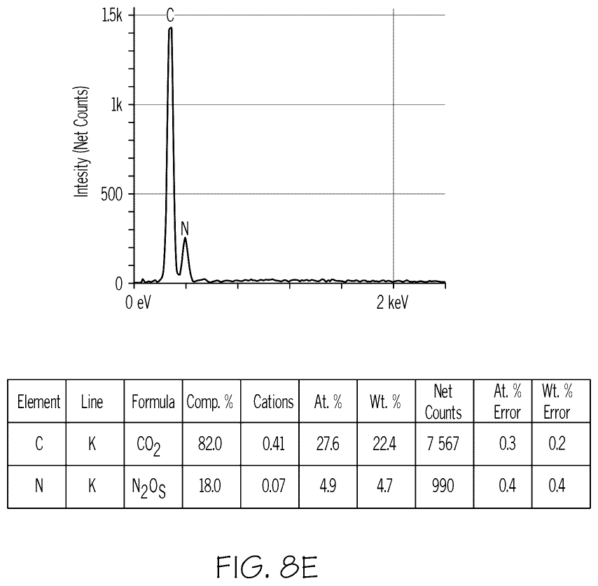

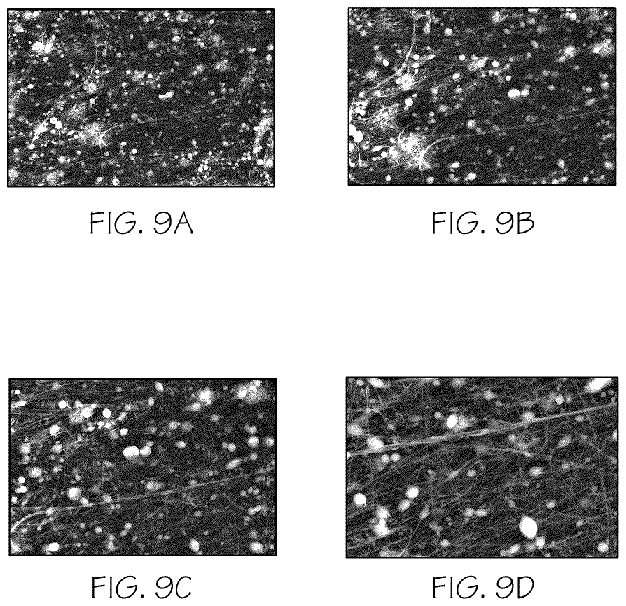

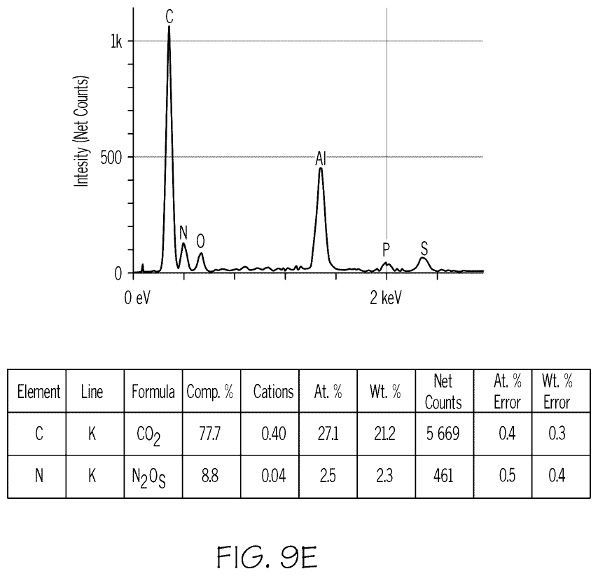

The resultant experiment produced a mat of fibers between 100 and 1000 nm. While there are some “beads-on-a-string” in the sample, the bulk is fibers. Scanning electron micrographs of the resultant fibers are shown in FIGS. 9A-9D at magnifications of 1000× (FIG. 9A), 1500× (FIG. 9B), 2000× (FIG. 9C), and 3500× (FIG. 9D).

Energy dispersive X-ray spectroscopy (EDS) Analysis was used to determine the elements found in each sample. The results are shown in FIG. 9E. For PAN, there should be only carbon (C) and nitrogen (N). The PolyCat 1 has carbon (C), nitrogen (N), sulfur (S), oxygen (O), and phosphorous (P). Note there are NO halogens (fluorine, chlorine, bromine, etc.). The samples were on aluminum foil to hold samples. This demonstrates that both polymers are found in the sample. The nitrogen concentration dropped since there is less nitrogen in the PolyCat 1 (N 2.42%) compared to PAN (26.4%).

### Example 5

### Coaxial Electrospinning of PAN in PC1

To produce fibers with the non-combustible polymer (PolyCat 1) on the surface of the fibers and the carrier combustible polymer (PAN) on the inside to produce more flame resistant polymer fibers, 1 solution of 10 wt % PAN in DMF (inside) was coaxially spun with 1 solution of 10 wt % PC1 in DMF (outside). The parameters were as follows: Nettle 1 (inside): solution of 10 wt % PAN in DMF; Nettle 2 (outside): solution of 10 wt % PC1 in DMF; Voltage (both nettles): 20.9 kV; Working Distance: 70 mm; Flow Rate Nettle 1: 0.01 mL/min; Flow Rate Nettle 2: 0.01 mL/min; and Drum Speed: 1000 rpm.

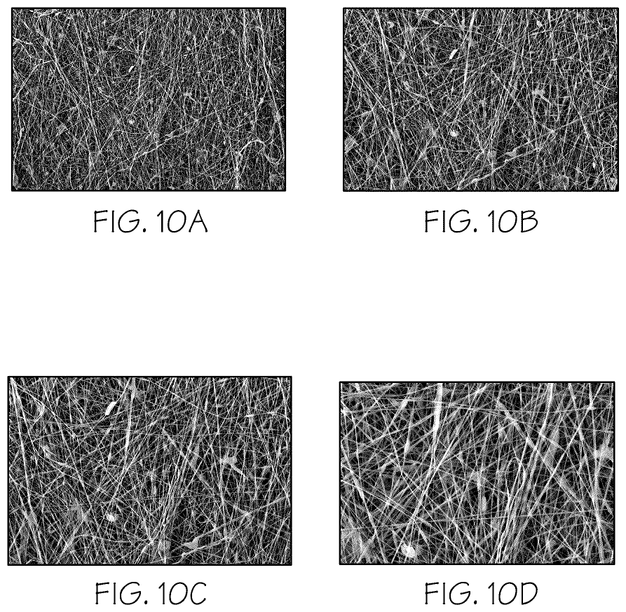

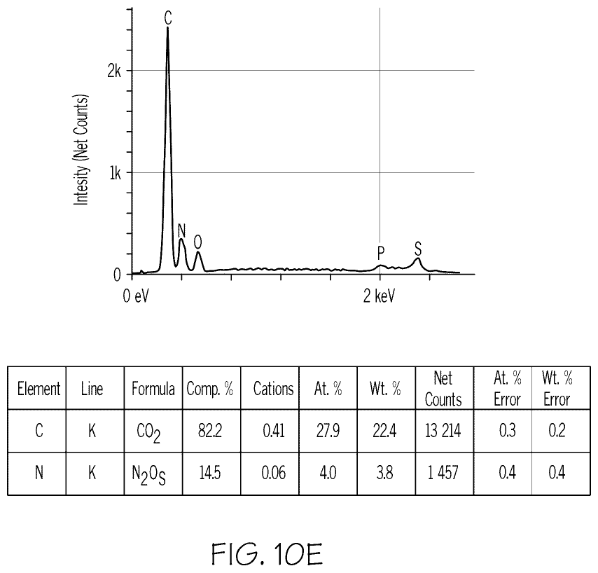

The resultant experiment produced a mat of fibers between 100 and 1000 nm. Scanning electron micrographs of the resultant fibers are shown in FIGS. 10A-10D at magnifications of 1000× (FIG. 10A), 1500× (FIG. 10B), 2000× (FIG. 10C), and 3500× (FIG. 10D). Energy dispersive X-ray spectroscopy (EDS) analysis was used to determine the elements found in each sample. The results are shown in FIG. 10E.

For PAN, there should be only carbon (C) and nitrogen (N). The PolyCat 1 has carbon (C), nitrogen (N), sulfur (S), oxygen (O), and phosphorous (P). Note there are NO halogens (fluorine, chlorine, bromine, etc.). The samples were on aluminum foil to hold samples. This demonstrates that both polymers are found in the sample. The nitrogen concentration dropped since there is less nitrogen in the PolyCat 1 (N 2.42%) compared to PAN (26.4%).

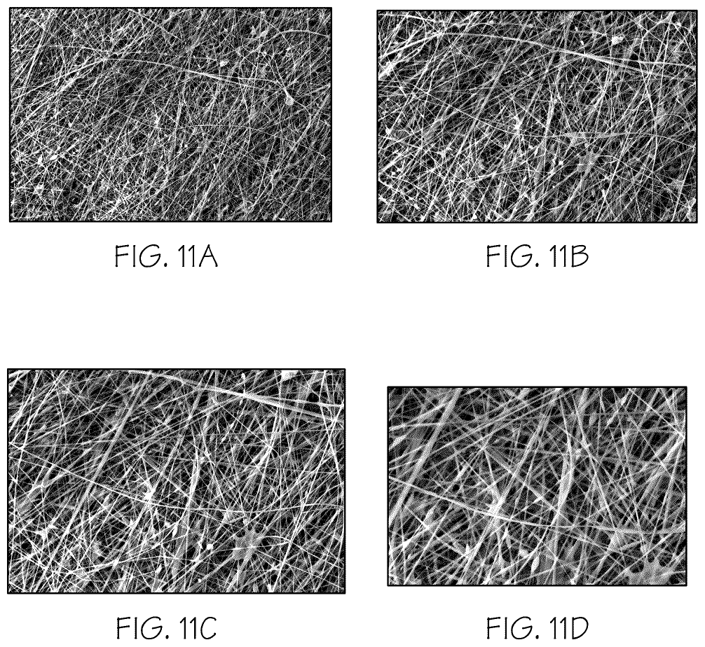

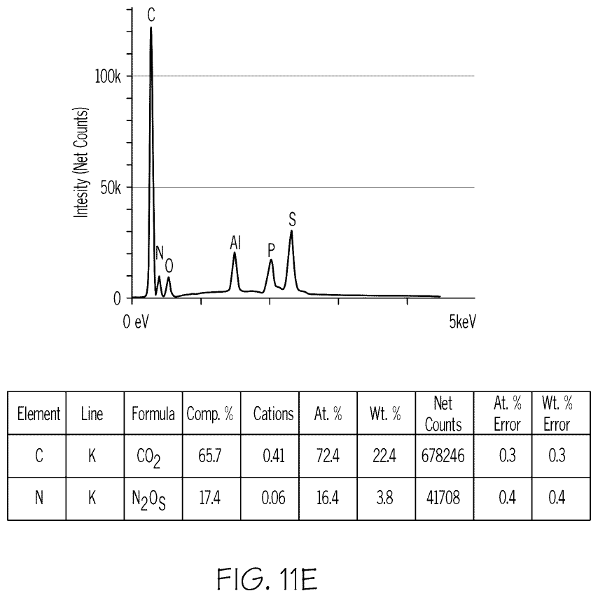

The resultant experiment was repeated and produced a mat of fibers between 100 and 1000 nm. Scanning electron micrographs of the resultant fibers are shown in FIGS. 11A-11D at magnifications of 1000× (FIG. 11A), 1500× (FIG. 11B), 2000× (FIG. 11C), and 3500× (FIG. 11D). Energy dispersive X-ray spectroscopy (EDS) analysis was used to determine the elements found in each sample. The results are shown in FIG. 11E.

### Example 6

### Flame Testing of the Fibers

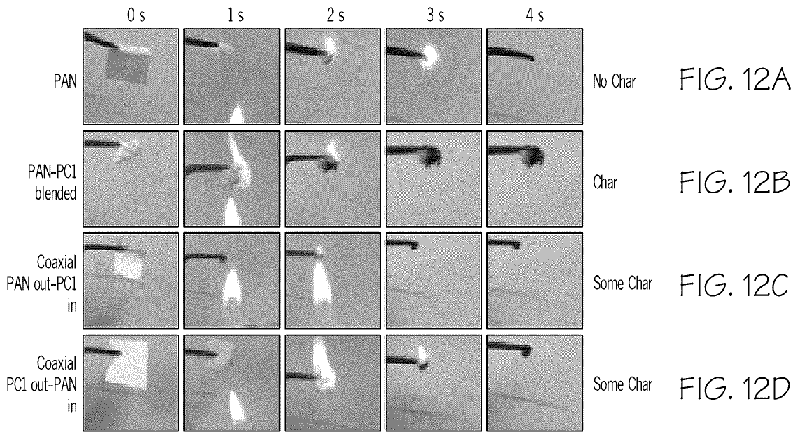

Fiber mats from Examples 3-5 were exposed to flame from a lighter for as long as needed to ignite (<1 sec.). The results are shown in FIG. 12A-12D. The PAN sample was fully burned (no mat remaining) within 4 seconds (No char) (FIG. 12A). The PAN-PC1 blended sample self-extinguished after 3 seconds (most of mat remained intact) (FIG. 12B). The first coaxial PAN out-PC1 in sample burned within 3 seconds (some charred mat remaining) (FIG. 12C). The second coaxial PAN in-PC1 out sample self-extinguished within 3 seconds (mat shriveled up and charred) (FIG. 12D). All of the samples with the FR additive exhibited char formation.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making a flame-retardant fiber on a surface, said method comprising:
electrospinning a polymer onto the surface,
wherein the polymer has a molecular weight of more than 10 kilodaltons; and
electrospinning a flame-retardant polymeric additive onto the surface.

2. The method of claim 1, wherein the surface comprises a battery surface, and wherein the method is used to form the fiber as a component of the battery.

3. The method of claim 2, wherein the method is used to form the fiber as a separator of the battery.

4. The method of claim 1, wherein the electrospinning occurs at a flow rate of at least about 0.01 mL/mm.

5. The method of claim 1, wherein the electrospinning occurs at a voltage of at least about 10,000 V.

6. The method of claim 1, wherein the electrospinning occurs at a drum speed of at least about 10 RPM.

7. The method of claim 1, wherein the electrospinning occurs at a surface distance of at least about 1 inch.

8. The method of claim 1, wherein a single electrospinning apparatus is used to electrospin the polymer and the flame-retardant polymeric additive onto the surface.

9. The method of claim 8, wherein the electrospinning of the polymer and the flame-retardant polymeric additive comprises:
mixing the polymer with the flame-retardant polymeric additive to form a mixture;
loading the mixture into an electrospinning apparatus; and
electrospinning the mixture onto the surface to form the fiber on the surface.

10. The method of claim 9, wherein the mixing occurs for at least 1 hour.

11. The method of claim 9, wherein the fiber comprises an intertwined blend of the polymer and the flame-retardant polymeric additive.

12. The method of claim 1, wherein a first electrospinning apparatus is used to electrospin the polymer onto the surface, and wherein a second electrospinning apparatus is used to electrospin the flame-retardant polymeric additive onto the surface.

13. The method of claim 12, wherein the method comprises:
loading the polymer into the first electrospinning apparatus and electrospinning the polymer onto the surface; and
loading the flame-retardant polymeric additive onto the second electrospinning apparatus and electrospinning the flame-retardant polymeric additive onto the surface.

14. The method of claim 13, wherein the method forms a coaxial fiber of the polymer and the flame-retardant polymeric additive.

15. The method of claim 13, wherein the fiber is in the form of a two-part fiber, wherein the two-part fiber comprises the polymer completely or partially containing the flame-retardant polymeric additive.

16. The method of claim 13, wherein the fiber comprises the polymer on the outside of the fiber and the flame-retardant polymeric additive on the inside of the fiber.

17. The method of claim 13, wherein the fiber is in the form of a two-part fiber, wherein the two-part fiber comprises the flame-retardant polymeric additive completely or partially containing the polymer.

18. The method of claim 17, wherein the fiber comprises the polymer on the inside of the fiber and the flame-retardant polymeric additive on the outside of the fiber.

19. The method of claim 1, wherein the polymer is selected from the group consisting of polyacrylonitriles, nylons, polyesters, polyolefins, thermoplastic polymers, or combinations thereof.

20. The method of claim 1, wherein the polymer comprises polyacrylonitrile.

21. The method of claim 1, wherein the flame-retardant polymeric additive is selected from the group consisting of phosphine-containing polymers, phosphine oxide-containing polymers, phosphine oxide poly(pyridinium), poly(pyridinium), poly(pyridinium) without phosphine oxide, poly(4,4′-(p-phenylene)-bis(2,6-diphenyl pyridinium)) di(4-methylbenzene sulfonate, or combinations thereof.

22. The method of claim 1, wherein the flame-retardant polymeric additive comprises poly(4,4′-(p-phenylene)-bis(2,6-diphenyl pyridinium)) di(4-methylbenzene sulfonate.

23. The method of claim 1, wherein the polymer has a net charge that is opposite the net charge of the flame-retardant polymeric additive.

24. The method of claim 1, wherein the fiber has a diameter ranging from about 10 nm to about 1000 nm.

25. The method of claim 1, wherein the fiber has a diameter of less than about 100 nm.

26. The method of claim 1, wherein the fiber has a surface area ranging from about 5 m²/g to about 500 m²/g.

27. A flame-retardant fiber comprising:
a polymer with a molecular weight of more than 10 kilodaltons; and
a flame-retardant polymeric additive associated with the polymer.

28. The fiber of claim 27, wherein the polymer is selected from the group consisting of polyacrylonitriles, nylons, polyesters, polyolefins, thermoplastic polymers, or combinations thereof.

29. The fiber of claim 27, wherein the polymer comprises polyacrylonitrile.

30. The fiber of claim 27, wherein the flame-retardant polymeric additive is selected from the group consisting of phosphine-containing polymers, phosphine oxide-containing polymers, phosphine oxide poly(pyridinium), poly(pyridinium), poly(pyridinium) without phosphine oxide, poly(4,4′-(p-phenylene)-bis(2,6-diphenyl pyridinium)) di(4-methylbenzene sulfonate, or combinations thereof.

31. The fiber of claim 27, wherein the flame-retardant polymeric additive comprises poly(4,4′-(p-phenylene)-bis(2,6-diphenyl pyridinium)) di(4-methylbenzene sulfonate.

32. The fiber of claim 27, wherein the polymer has a net charge that is opposite the net charge of the flame-retardant polymeric additive.

33. The fiber of claim 27, wherein the fiber comprises an intertwined blend of the polymer and the flame-retardant polymeric additive.

34. The fiber of claim 27, wherein the fiber is in the form of a two-part fiber, wherein the two-part fiber comprises the polymer completely or partially containing the flame-retardant polymeric additive.

35. The fiber of claim 27, wherein the fiber comprises the polymer on the outside of the fiber and the flame-retardant polymeric additive on the inside of the fiber.

36. The fiber of claim 27, wherein the fiber is in the form of a two-part fiber, wherein the two-part fiber comprises the flame-retardant polymeric additive completely or partially containing the polymer.

37. The fiber of claim 36, wherein the fiber comprises the polymer on the inside of the fiber and the flame-retardant polymeric additive on the outside of the fiber.

38. The fiber of claim 27. wherein the fiber has a diameter ranging from about 10 nm to about 1000 nm.

39. The fiber of claim 27. wherein the fiber has a diameter of less than about 100 nm.
